(19) United States
(12) Patent Application Publication
(10) Pub. No.: US 2004/0102998 A1
(43) Pub. Date: May 27, 2004

(54) System and method to support patient identifiers for imaging and information systems in health care enterprise

(75) Inventors: Yongjian Bao, Vernon Hills, IL (US); Lori W. Martin, Crystal Lake, IL (US); Vadim Berezhanskiy, Arlington Heights, IL (US); Jay Nayanaveettil, Arlington Heights, IL (US); Atulkishen Setlur, Chicago, IL (US); Neil D'Souza, Mt. Prospect, IL (US); Prakash Mathew, Wheaton, IL (US); Xiaofeng Xu, Des Plaines, IL (US); Todd Lomaro, Algonquin, IL (US)

Correspondence Address: FOLEY & LARDNER, 777 EAST WISCONSIN AVENUE, SUITE 3800, MILWAUKEE, WI, 53202-5308, US

(73) Assignee: GE Medical Systems Information Technologies, Inc.

(21) Appl. No.: 10/304,204

(22) Filed: Nov. 26, 2002

(51) Int. Cl. G06F 17/60

(52) U.S. Cl. 705/2

(57) ABSTRACT

A system and method to identify a patient for imaging and information systems in a health care enterprise. A health care enterprise has a facility which includes typically equipment and the user. The system comprises the means for assigning a patient identifier-domain (PIDD) to a patient registration service in the health care enterprise. A means for assigning a default patient-identifier-domain (Default PIDD) to each facility, equipment and user. A means for assigning a patient-identifier (PID) to the patient. A means for assigning a global patient-identifier-domain identification (PIDD-ID) to each PIDD. A means for associating each PIDD with the PIDD-ID. And a means for associating the PID with the PIDD to create a unique patient identifier.

### BACKGROUND OF THE INVENTION

The present invention relates to the system and method for providing a unique patient identifier for a patient in a health care enterprise.

When a patient enters into a health care enterprise, a registration procedure is performed. The registration typically includes the name of the patient, age of the patient, social security number of the patient, sex of the patient and an address of the patient. It is also not unusual that multiple independent patient registration services are performed within a health care enterprise for the same patient. For example, a registration may be required in the emergency room with additional registration taking place in an x-ray lab or an orthopedic clinic or at the health care enterprise pharmacy, etc. It is also possible that the patient may be admitted to different hospitals, clinics, institutions or departments within or without the health care enterprise in which patient records are created and managed. It is typical that one patient may be assigned different patient ID numbers as they are diagnosed or treated at each of these organizational units. A problem arises when the health care enterprise requires that such patient information, on an enterprise-wide basis, and patient records be linked together and maintained as a single patient folder and linked to the health care enterprises' imaging and information systems, such as a picture archiving and communication system (PACS).

Thus, there is a need for a system to identify the patient for imaging and information systems in a health care enterprise that is unique to such patient. There is a further need for a method to identify a patient for imaging and information systems in a health care enterprise in maintaining such patient identifier throughout the health care enterprise system.

### SUMMARY OF THE INVENTION

There is provided an exemplary embodiment of a system to identify a patient for imaging and information systems in a health care enterprise. A health care enterprise has a facility which includes typically equipment and the user. The system comprises the means for assigning a patient identifier-domain (PIDD) to each patient registration service in the health care enterprise. A means for assigning a default patient-identifier-domain (Default PIDD) to each facility, equipment and user. A means for assigning a patient-identifier (PID) to the patient. A means for assigning a global patient-identifier-domain identification (PIDD-ID) to each PIDD. A means for associating each PIDD with the PIDD-ID. And a means for associating the PID with the PIDD to create a unique patient identifier.

There is also provided a method to identify a patient for imaging and information systems in a health care enterprise. The health care enterprise typically is a facility which includes equipment and a user. The method comprises the steps of assigning a patient-identifier-domain (PIDD) to each patient registration service in the health care enterprise. Assigning a default patient-identifier-domain (Default PIDD) to each facility, equipment and user. Assigning a patient-identifier (PID) to the patient. Assigning a global patient-identifier-domain identification (PIDD-ID) to each PIDD. Associating each PIDD with the PIDD-ID and associating the PID with the PIDD to create a unique patient identifier.

### BRIEF DESCRIPTION OF THE DRAWINGS

FIG. 1 is a block diagram of a patient identification model in a database that links a patient (P) with a patient-identifier (PID) and a patient-identifier-domain (PIDD) to create a unique patient identifier.

FIG. 2 is a block diagram of an exemplary embodiment of a patient-identifier-domain configuration associating PIDD information with a facility and its equipment within the departments of a health care enterprise.

FIG. 3 is an exemplary embodiment of a system displaying an example of a look-up table, electronic order record and patient identifier information stored on a storage device associated with the system.

FIG. 4 is a flow chart diagram of an exemplary embodiment of a patient-identifier using patient identifier (PID) and patient-identifier-domain (PIDD) information accessible in the system.

### DETAILED DESCRIPTION OF THE EXEMPLARY EMBODIMENTS

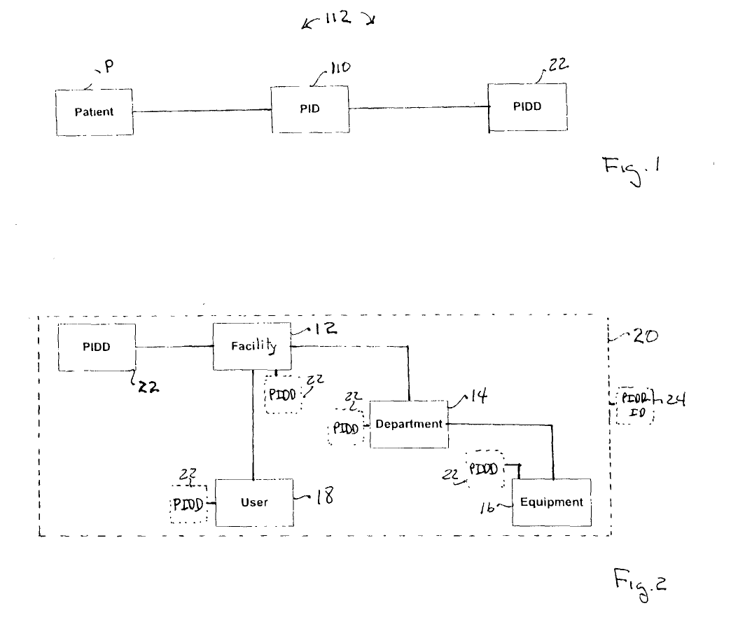

Referring to the figures, FIG. 1 is a block diagram of a patient identification model in a database. The patient entity (P) models a real-world patient. The patient identification information (PID) 110 models a real-world patient ID data entry which consists of attributes assigned to the patient (P). Such attributes can be, but is not limited to, the name of the patient, an age of the patient, a social security number of the patient, sex of the patient, an address of the patient, or such other information as selected by the user and is available on the system 10. The PID 110 can also be a number assigned by a particular patient registration service. Each issuer of a PID 110 is modeled as a patient-identification-domain entity (PIDD). The PIDD 22 models a real-world domain in which all PID's are issued from the same system in a consistent way.

A health care enterprise 20 can be assigned a unique identification (PIDD-ID) 24. Within such health care enterprise 20, each facility 12 will be assigned a default PIDD 22 together with each department 14 and equipment 16 utilized within that department 14 of the facility 12. A separate Default PIDD is assigned to each such entity and each PIDD 22 is associated with the PIDD-ID 24 within the system 10. Each PID 110 and PIDD 22 are linked to form a unique patient identification 112 within the health care enterprise 20. The various PID, PIDD, Default PIDD, and PIDD-ID values are stored in a look-up table 108 maintained on a storage device 106 within or associated with the system 10.

In some cases, a PIDD 22 is related to some geographic/organizational scope. For example, a PIDD can be assigned to a main hospital, a different PIDD can be assigned to an orthopedic clinic associated with that hospital and a third PIDD can be assigned to an imaging center also associated with the main hospital. A patient entering each of these entities can be assigned a different patient identification (PID) by a separate patient registration service with each PID being linked to the unique PIDD to create a unique patient identifier 112 that will be used throughout the system 10.

FIG. 2 is a block diagram of an exemplary embodiment of a patient identifier-domain configuration associating a PIDD 22 information with a facility 12 and its equipment 16 within a department 14 of a health care enterprise 20. Each equipment 16 is associated with a PIDD 22 with its department 14 and facility 12 relationship. A user entity 18, such as a physician or other health care provider, is assigned a separate PIDD 22 associated with the facility 12 of the health care enterprise 20.

Multiple PIDs can be associated with one patient (P) and for each PID 110, its PIDD 22 is recorded which indicates what PIDD 22 generated this PID 110. The system will not use a PID 110 alone, because it is treated as part of a patient identifier 112. The pair of PIDD 22 and the PID 110 together forms a complete definition of the patient identifier 112. This definition is used in all contexts where a patient identifier 112 is needed, including but not limited to a query, a matching, display, a print, a message, communication, etc. within the system 10. A patient (P) can be associated with more than one unique patient identifier. Such cases can result when a patient (P) is registered in a facility that is outside the enterprise or different types of equipment are used in that patient's care.

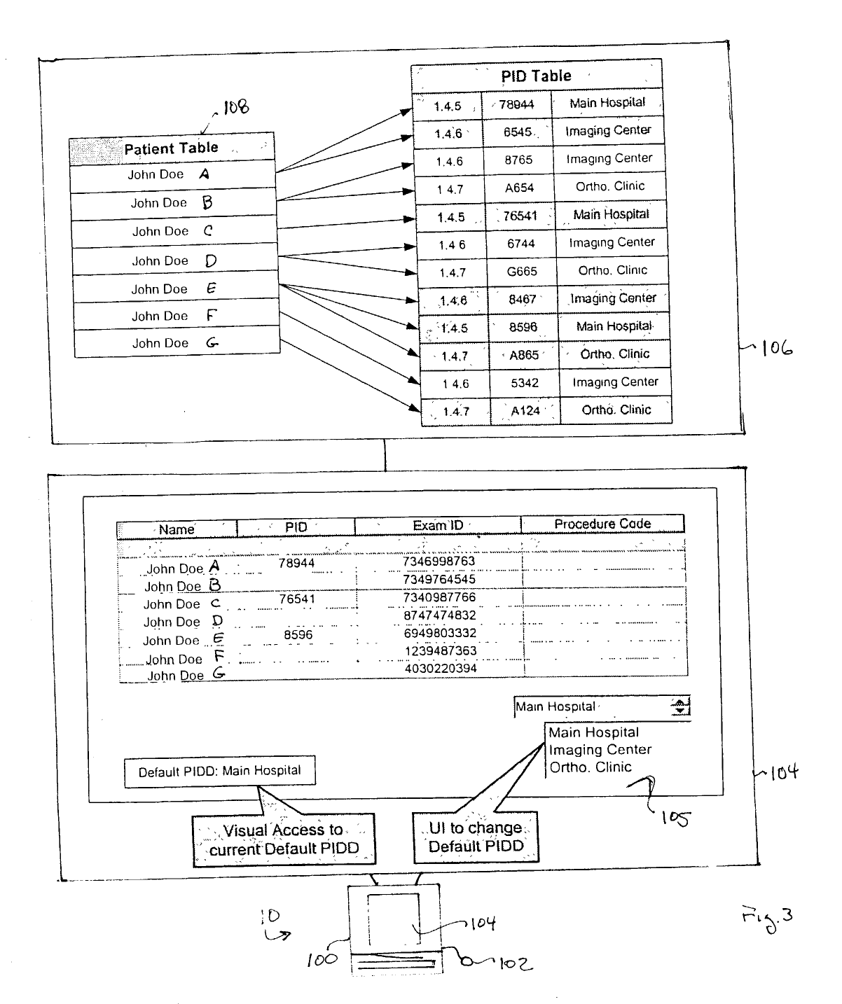

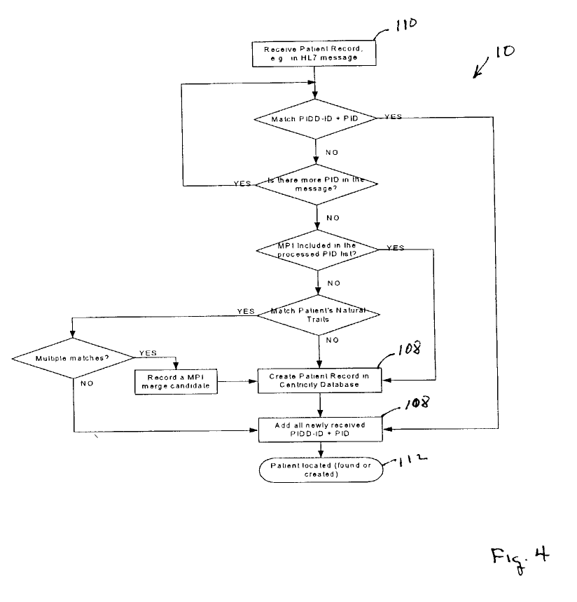

FIG. 3 is an exemplary embodiment of the system displaying an example of a look-up table 108, electronic record 110 of patient identifier 112 information stored on a storage device 106 associated with the system 10. The system 10 typically includes an operator console 100 that has a display screen 104 and an input device 102. The graphical user interface 105 is displayed on the display screen 104 of the system 10. The display includes look-up table 108 and various other icons to provide information to the user of the system.

In operation, a Default PIDD is displayed with associated information from the look-up table 108 displayed on the display screen 104. A user interface 105 can provide for a changing of the Default PIDD to a different PIDD with corresponding information retrieved from the look-up table 108 and displayed on the display screen 104.

In the illustration shown in FIG. 3, the Default PIDD is the main hospital of the exemplary health care enterprise 20 with the three patients (P) that were assigned a PID 110 by the main hospital PIDD displayed on the display screen 104. The patients that were not assigned a PID by the selected Default PIDD are shown as not having a PID.

Changing the Default PIDD or other activities at the operator console 100 are performed by an input device 102. The input device 102 can be selected from a group including a mouse, a joystick, a keyboard, a touch ball, a touch screen, a voice recognition control, and a light wand. For example, “clicking” on the Default PIDD icon of the user interface 105 instructs the system 10 that a change will be made. The operator or user then selects the PIDD of interest which changes it to the then current Default PIDD with the system 10 then obtaining the appropriate information from the look-up table 108 stored on the storage device 106 associated with the system 10. The storage device 106 can include, but is not limited to, any type of disk including floppy disks, hard disks, optical disks, CD-ROMs and magneto-optical disks, ROMs, RAMs, EPROMs, EEPROMs, magnetic and optical cards or any type of media suitable for storing electronic instructions.

It should be understood that the operator console 10 can be a general purpose computer or it can be a work station coupled to a server or mainframe which is a part of the system 10. It is also contemplated that the communication between the operator console 100 and the storage device 106 can be by hardwire, radio or optical transmission of energy represented of the information of interest.

If stored in any one of the above described storage media, the system includes programming for controlling both the hardware of the system 10 and for enabling the operator console 100 to interact with a human user. Such programming may include, but is not limited to, software for implementation of device drivers, operating systems, and user applications. Such computer readable media further includes programming or software instructions to direct the system to perform the tasks in accordance with the present invention.

FIG. 4 is a flow chart diagram of an exemplary embodiment of a patient identifier 112 using patient identifiers (PID) 110 and patient-identification-domain (PIDD) information 22 accessible within the system 10. Received electronic order record 110 of a patient (P) is entered into the system and it is matched to a PID domain. If a match exists, it is entered as a patient identifier 112. If no match exists, additional PID information is obtained and the system 10 will continually try and match the patient PID information with the PIDD information until a match is made or created and stored in the patient record in the imaging and information system, such as a picture archiving communication system (PACS) and maintained in the look-up table 108 associated with the system 10.

A method to identify a patient (P) for imaging and information systems (PACS) in a health care enterprise 20 having a facility 12 including equipment 16 and the user 18 is provided. The method comprises the step of assigning a patient-identifier-domain (PIDD) 24 to each patient registration service in the health care enterprise 20. Assigning a patient-identifier-domain (PIDD) 22 to each facility 12, equipment 16 and user 18. Assigning a patient identifier (PID) 110 to the patient (P). Assign a global patient-identifier-domain-identification (PIDD-ID) to each PIDD. Associating each PIDD 22 with the PID-ID 24 and associating the PID 110 with a selected PIDD 22 to create a unique patient identifier 112. The method can also include the step of storing the PID 110, the PIDD 22, and PIDD-ID 24 in a look-up table 108 on a storage device 106. The storage device 106 can be in the facility 12 or can be outside of the facility but coupled to the system 10 by appropriate communication facilities.

The method can also include the step of displaying the look-up table 108 on the equipment 16 with a display including a user interface 105 which displays a default PIDD. The display also included tool for changing the default PIDD using an input device 102 selected from a group consisting of a mouse, a joystick, a keyboard, a track ball, a touch screen, a voice recognition control, and a light wand. Additional PID 110 of different PIDD 22 can be associated with a patient (P) creating a multiple patient identifiers supported for the patient which presents an integrated view of all of his/her clinical data, while the information is readily received from different sources within the health care enterprise 20.

Thus, there is provided a method to support multiple patient identifiers for imaging and information systems in a health care enterprise. Obviously, numerous modifications and variations of the described method and system, are possible in light of the above teachings. It is therefore, to be understood that within the scope of the appended claims, the invention may be practiced otherwise in a specifically described herein.

What is claimed is:

1. A method to identify a patient for imaging and information systems in a healthcare enterprise having a facility including equipment and a user, the method comprising the steps of:
assigning a patient-identifier-domain (PIDD) to each patient registration service in the health care enterprise;
assigning a default patient-identifier-domain (Default PIDD) to each facility, equipment and user;
assigning a patient-identifier (PID) to the patient;
assigning a global patient-identifier-domain-identification (PIDD-ID) to each PIDD;
associating each PIDD with the PIDD-ID; and
associating the PID with the PIDD to create a unique patient identifier.

2. The method of claim 1, including the step of storing the PID, PIDD, Default PIDD, and PIDD-ID in a look-up table on a storage device.

3. The method of claim 2, wherein the storage device is in the facility.

4. The method of claim 2, including the step of displaying the look-up table on the equipment.

5. The method of claim 4, wherein the displaying includes a user interface (UI) which displays the Default PIDD.

6. The method of claim 5, including the step of changing the Default PIDD.

7. The method of claim 6, wherein the step of changing is performed by an input device selected from a group consisting of a mouse, a joystick, a keyboard, a track ball, a touch screen, a voice recognition control and a light wand.

8. The method of claim 1, including the step of associating the patient with at least one unique patient identifier.

9. The method of claim 1, wherein the PID is represented by an electronic order record selected from a group consisting of: a name of the patient, an age of the patient, a social security number of the patient, a sex of the patient, and an address of the patient.

10. A system to identify a patient for imaging and information systems in a healthcare enterprise having a facility including equipment and a user, the system comprising:
a means for assigning a patient-identifier-domain (PIDD) to the healthcare enterprise;
a means for assigning a default patient-identifier-domain (Default PIDD) to each facility, equipment and user;
a means for assigning a patient-identifier (PID) to the patient;
a means for assigning a global patient-identifier-domain identification (PIDD-ID) to each PIDD;
a means for associating each PIDD with the PIDD-ID; and
a means for associating the PID with the PIDD to create a unique patient identifier.

11. The system of claim 10, including a means for storing configured to store the PID, PIDD, Default PIDD, and PIDD-ID in a look-up table.

12. The system of claim 11, wherein the a means for storing is in the facility.

13. The system of claim 11, including a means for displaying the look-up table on the equipment.

14. The system of claim 13, wherein the means for displaying includes a means for interfacing which displays the Default PIDD.

15. The system of claim 14, including a means for changing the Default PIDD.

16. The system of claim 15, wherein the means for changing is performed by an input device selected from a group consisting of a mouse, a joystick, a keyboard, a track ball, a touch screen, a voice recognition control and a light wand.

17. The system of claim 10, including a means for associating the patient with at least one unique patient identifier.

18. The system of claim 10, wherein the means for assigning the PID is represented by an electronic order record selected from a group consisting of: a name of the patient, an age of the patient, a social security number of the patient, a sex of the patient, and an address of the patient.
